(19) United States
(12) Patent Application Publication
(10) Pub. No.: US 2023/0230076 A1
(43) Pub. Date: Jul. 20, 2023

(54) AGREEMENTS ON THE BLOCKCHAIN

(71) Applicant: nChain Licensing AG, Zug (CH)

(72) Inventors: Jack Owen DAVIES, London (GB); Daniel JOSEPH, London (GB); Craig Steven WRIGHT, London (GB)

(21) Appl. No.: 18/009,323

(22) PCT Filed: May 17, 2021
(86) PCT No.: PCT/EP2021/062944

§ 371 Date: Dec. 8, 2022

(30) Foreign Application Priority Data
Jun. 17, 2020 (GB) 2009232.6

(51) Int. Cl. G06Q 20/38; G06Q 20/40; G06Q 20/02

(52) U.S. Cl. CPC G06Q 20/3827; G06Q 20/407; G06Q 20/3825; G06Q 20/02

(57) ABSTRACT

A computer-implemented method of recording an agreement between a requesting party and a confirming party on a blockchain, wherein the method is performed by the requesting party and comprises: generating a request transaction, wherein the request transaction comprises an input signed by the requesting party, and at least a first output comprising a cryptographic puzzle based on a first data item known to both the requesting and confirming parties, wherein the first data item represents the agreement; and causing the request transaction to be transmitted to one or more blockchain nodes.

### CROSS REFERENCE TO RELATED APPLICATIONS

This application is the U.S. National Stage of International Application No. PCT/EP2021/062944 filed on May 17, 2021, which claims the benefit of United Kingdom Patent Application No. 2009232.6, filed on Jun. 17, 2020, the contents of which are incorporated herein by reference in their entireties.

### TECHNICAL FIELD

The present disclosure relates to a method of recording an agreement between a requesting party and a confirming party on a blockchain, and more specifically to proving consent to the agreement by both parties.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks up until one or more coinbase transactions. Coinbase transactions are discussed below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at a node, and the publication of blocks can be achieved through the publication of mere block headers.

The transactions in the blockchain are used to perform one or more of the following: to convey a digital asset(i.e. a number of digital tokens), to order a set of journal entries in a virtualised ledger or registry, to receive and process timestamp entries, and/or to time-order index pointers. A blockchain can also be exploited in order to layer additional functionality on top of the blockchain. Blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in detail below. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

### SUMMARY

The blockchain can be used to record an agreement (e.g. a legal contract) between two parties. For instance, the agreement may be included in a transaction, which when submitted to the blockchain network, will be published on the blockchain. Whilst this is useful, it would be beneficial to be able to evidence that both parties have given their explicit consent or approval of the agreement. This ‘proof of consent’ may be used by both parties to the agreement for contract enforcement, dispute resolution, etc.

According to one aspect disclosed herein, there is provided a computer-implemented method of recording an agreement between a requesting party and a confirming party on a blockchain, wherein the method is performed by the requesting party and comprises: generating a request transaction, wherein the request transaction comprises an input signed by the requesting party, and at least a first output comprising a cryptographic puzzle based on a first data item known to both the requesting and confirming parties, wherein the first data item represents the agreement; and causing the request transaction to be transmitted to one or more blockchain nodes.

According to one aspect disclosed herein, there is provided a computer-implemented method of recording an agreement between a requesting party and a confirming party using a blockchain, wherein the method is performed by the confirming party and comprises: generating a confirmation transaction, wherein the confirmation transaction comprises an input referencing an output of a request transaction, wherein the output of the request transaction comprises a cryptographic puzzle based on a first data item known to both the requesting and confirming parties and representing the agreement, and wherein the input of the confirmation transaction comprises the first data item; and causing the confirmation transaction to be transmitted to one or more blockchain nodes.

The requesting party (say, Alice) sets up a cryptographic puzzle that, in order to be solved, requires knowledge of the agreement to which Alice wishes to enter with a confirming party (say, Bob). That is, the request transaction submitted to the blockchain network by Alice includes an output that includes the cryptographic puzzle. In order for the output to be unlocked, an input of Bob's transaction that references the output must include a solution to the cryptographic puzzle. As an example, the cryptographic puzzle may be a hash puzzle that requires Bob to provide a hash of the agreement, or as an alternative example, the agreement itself.

To accept the agreement, Bob generates a confirmation transaction that includes an input containing a solution to the cryptographic puzzle. Due to the nature of cryptographic puzzles, Alice's puzzle will only be unlocked by a unique solution, e.g. the agreement or a hash of the agreement. By providing the unique solution, Bob therefore gives his consent to the agreement. If, on the other hand, Alice and Bob were in fact wanting to enter into different agreements (e.g. with different terms or conditions), then Bob's solution would not unlock Alice's puzzle. This would alert both Alice and Bob that the requested agreement has not been confirmed.

A particular use case for the present invention is in the field of licensing agreements, e.g. intellectual property (IP) licensing. Bob may be the owner of the IP and Alice may want to license the IP. Alice can request a license for the IP by submitting a request transaction to the blockchain network. The request transaction includes a cryptographic puzzle based on a licensing agreement (LA) for the IP, e.g. a hash puzzle may include the double-hash of the LA. If Bob agrees to license the IP to Alice under the terms of the LA, Bob submits a confirmation transaction to the blockchain network that includes a solution to the cryptographic puzzle, e.g. the hash of the LA. The publishing of the request and confirmation transaction on the blockchain acts as an immutable record of the mutual consent to the LA by both parties.

Note that whilst described in terms of the licensee generating the request transaction and the licensor generating the confirmation transaction, it is also not excluded that the roles may be reversed. That is, the licensor may generate the request transaction that acts as an offer of the LA, and the licensee may generate the confirmation transaction that acts an acceptance of the LA.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3A is a schematic block diagram of a client application,

FIG. 3B is a schematic mock-up of an example user interface that may be presented by the client application of FIG. 3A,

FIG. 4 is a schematic block diagram of a system for implementing embodiments of the invention,

FIG. 5 schematically illustrates an example flow of transactions for implementing some embodiments of the invention,

FIG. 6 schematically illustrates an example advertisement transaction,

FIG. 7 schematically illustrates an example request transaction,

FIG. 8 schematically illustrates an example confirmation transaction,

FIG. 9 schematically illustrates an example update transaction,

FIG. 10 schematically illustrates an example refund transaction, and

FIG. 11 is an example sequencing diagram for implementing some embodiments of the invention.

### DETAILED DESCRIPTION OF EMBODIMENTS

### Example System Overview

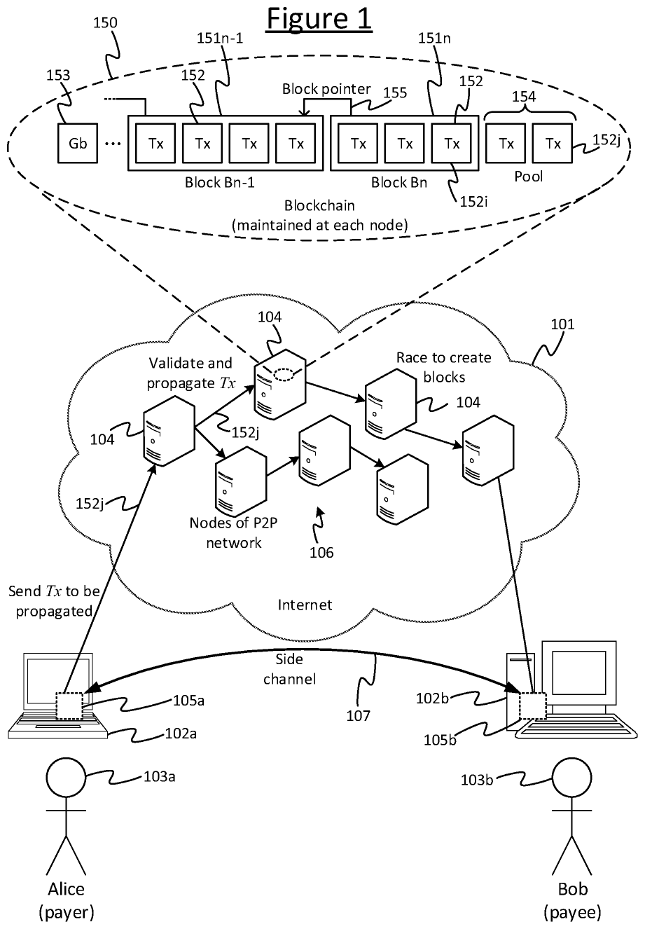

FIG. 1 shows an example system 100 for implementing a blockchain 150. The system 100 may comprise of a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as Application Specific Integrated Circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 160. As mentioned above, maintaining a copy of the blockchain 150 does not necessarily mean storing the blockchain 150 in full. Instead, the blockchain 150 may be pruned of data so long as each blockchain node 150 stores the blockheader (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set 154 of transactions 152 waiting to be incorporated into blocks 151. The ordered set 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when an entity, such as a user or machine, 103 wishes to enact a new transaction 152j, then the entity sends the new transaction from its computer terminal 102 to a recipient. The entity or the recipient will eventually send this transaction to one or more of the blockchain nodes 104 of the network 106 (which nowadays are typically servers or data centres, but could in principle be other user terminals). It is also not excluded that the entity 103 enacting the new transaction 152j could send the transaction to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the entity 103 included in the input of the new transaction 152j matches a condition defined in the output of the preceding transaction 152i which the new transaction assigns, wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned is whether it has yet been validly redeemed by the input of another, onward transaction 152j according to the blockchain node protocol. Another condition for a transaction to be valid is that the output of the preceding transaction 152i which it attempts to assign or redeem has not already been assigned/redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered set 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered set of transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. A significant amount of effort, for example in the form of hash, required to create a proof-of-work solution signals the intent of the first node 104 to follow the rules of the blockchain protocol. Such rules include not accepting a transaction as valid if it assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the ordered set of yet to be published transactions 154 at any given time, depending on when they started searching for a solution or the order in which the transactions were received. Whoever solves their respective puzzle first defines which transactions 152 are included in the next new block 151n and in which order, and the current set 154 of unpublished transactions is updated. The blockchain nodes 104 then continue to race to create a block from the newly defined outstanding ordered set of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to assign an accepted amount of the digital asset in a new special kind of transaction which distributes a defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network but do not participate in validating, constructing or propagating transactions and blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered set of transactions 154 maintained at a given blockchain node 104, that blockchain node 104 will start competing to solve the proof-of-work puzzle on the latest version of their respective ordered set of transactions 154 including the new transaction 152 (recall that other blockchain nodes 104 may be trying to solve the puzzle based on a different ordered set of transactions 154, but whoever gets there first will define the ordered set of transactions that are included in the latest block 151. Eventually a blockchain node 104 will solve the puzzle for a part of the ordered set 154 which includes Alice's transaction 152j). Once the proof-of-work has been done for the ordered set 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### UTXO-Based Model

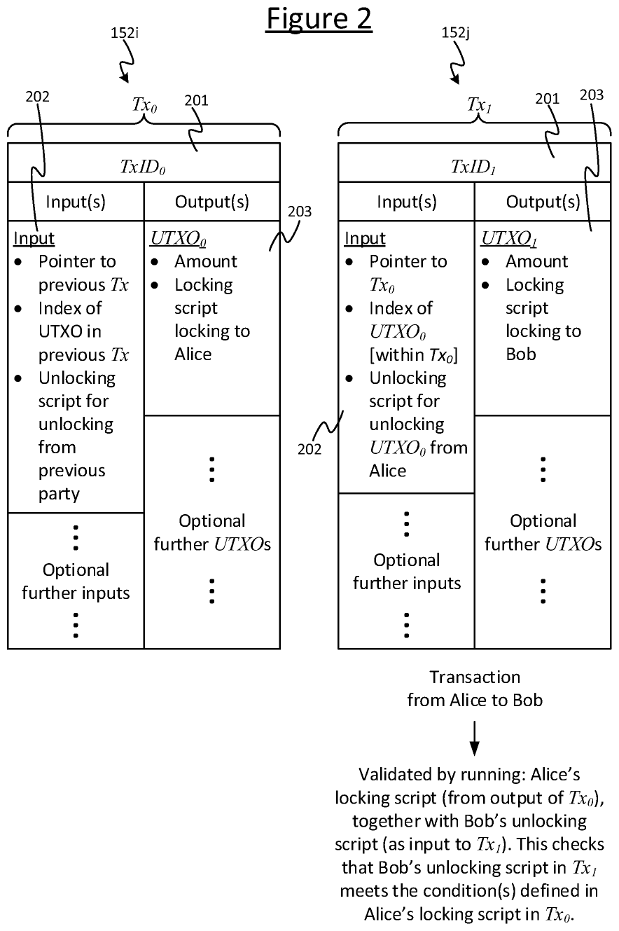

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀o. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:

<Sig P_{A}><P_{A}>||[Checksig P_{A}]

where “||” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered set of transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node that publishes her transaction 104. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned by the node 104 that publishes the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_. . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 107 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### Client Software

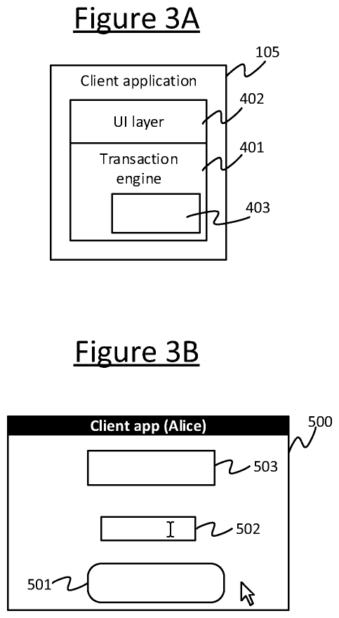

FIG. 3A illustrates an example implementation of the client application 105 for implementing embodiments of the presently disclosed scheme. The client application 105 comprises a transaction engine 401 and a user interface (UI) layer 402. The transaction engine 401 is configured to implement the underlying transaction-related functionality of the client 105, such as to formulate transactions 152, receive and/or send transactions and/or other data over the side channel 107, and/or send transactions to one or more nodes 104 to be propagated through the blockchain network 106, in accordance with the schemes discussed above and as discussed in further detail shortly. In accordance with embodiments disclosed herein, the transaction engine 401 of each client 105 comprises a function 403 for generating one, some or all of a request transaction, a confirmation transaction, a refund transaction, a revocation transaction, an update transaction and an advertisement transaction, as discussed below.

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could comprise one or more display screens (touch or non-touch screen) for providing a visual output, one or more speakers for providing an audio output, and/or one or more haptic output devices for providing a tactile output, etc. The user input means could comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

FIG. 3B gives a mock-up of an example of the user interface (UI) 500 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 3B shows the UI 500 from Alice's perspective. The UI 500 may comprise one or more UI elements 501, 502, 502 rendered as distinct UI elements via the user output means.

For example, the UI elements may comprise one or more user-selectable elements 501 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands). The options enable the user to include the required data in one, some or all of a request transaction, a confirmation transaction, a refund transaction, a revocation transaction, an update transaction and an advertisement transaction, as discussed below.

Alternatively or additionally, the UI elements may comprise one or more data entry fields 502, through which the user can enter the data mentioned above. These data entry fields are rendered via the user output means, e.g. on-screen, and the data can be entered into the fields through the user input means, e.g. a keyboard or touchscreen. Alternatively the data could be received orally for example based on speech recognition.

Alternatively or additionally, the UI elements may comprise one or more information elements 503 output to output information to the user. E.g. this/these could be rendered on screen or audibly.

It will be appreciated that the particular means of rendering the various UI elements, selecting the options and entering data is not material. The functionality of these UI elements will be discussed in more detail shortly. It will also be appreciated that the UI 500 shown in FIG. 3 is only a schematized mock-up and in practice it may comprise one or more further UI elements, which for conciseness are not illustrated.

### Preliminaries

### Cryptographic Hash Functions

Hash functions are used extensively in blockchain implementations as a means of mapping arbitrary length data to strings of fixed-length. In general, cryptographic hash functions are used to ensure this is done in a secure manner, and that the outputs of these hash functions are unique. In general, a hash function is considered cryptographically secure if it has the following properties:
1. Pre-image resistant—given h=H(m), it is computationally difficult to find m;
2. Second pre-image resistant—given h=H(m) and m, it is computationally difficult to find m′ such that H(m′)=h; and
3. Collision resistant—it is computationally difficult to find a pair of messages m and m′ such that H(m)=H(m′).

On the blockchain 150, a transaction identifier TxID is normally generated using the SHA-256 cryptographic hash function, and therefore inherits the properties of a hash function's digest.

### Hash Puzzles

A common technique used in the construction of locking scripts in is the hash puzzle. These puzzles are simple challenges, written in script, that force an assignee to provide the correct preimage X for a given hash digest H(X) set by an assignor. These puzzles are written as:

[Hash Puzzle H(X)]=OP_SHA256<H(X)>OP_EQUAL

### Storage of Data on the Blockchain

As the adoption of blockchain technology grows, along with the scaling infrastructure to support this, there is an increasing interest in inserting large volumes of data on the blockchain 150. It is indeed possible to store data on the blockchain 150 through usage of the various fields of a blockchain transaction 152. The storage of data on the blockchain 150 can be done broadly in one of two ways; either using the unspendable OP_RETURN opcode or using an OP_DROP statement.

According to some blockchain protocols, transaction outputs marked with an OP_RETURN opcode are known as provably unspendable outputs because OP_RETURN will cause a script execution to fail. According to other blockchain protocols, a transaction output is made provably unspendable by marking the output with the opcodes OP_FALSE OP_RETURN, or OP_0 OP_RETURN. As used herein, “OP_RETURN” is used as shorthand for “OP_FALSE OP_RETURN” or “OP_0 OP_RETURN”. It is therefore possible to store any data after such an opcode in a locking script of the following type:

### OP_RETURN <D>

It is not a requirement that a blockchain node 104 execute any script that follows an OP_RETURN opcode, which means this method of storing data has the advantage that it does not need to meet any formatting requirements that would normally apply to data stored in a portion of script.

An alternative method that can be used to store data in a blockchain transaction 152 is using the OP_DROP opcode. This can be used in a locking or unlocking script of the form

OP_PUSHDATA D OP_DROP

which is normally expressed more simply by replacing the OP_PUSHDATA opcode with angle brackets surrounding the data element being pushed to the stack as

<D>OP_DROP

Note however that data stored in such a script is subject to script-level checks that are incorporated by script execution and transaction validation.

### Use of Multi-Signature Scripts

It is possible to construct a transaction locking script that can be unlocked by providing any m-of-n signatures corresponding to m-of-n specific public keys. The locking script condition for such a multi-signature transaction is written as

[CheckMultisig m-of-n]=OP_m<P₁> . . . <Pₙ>OP_n OP_CHECKMULTISIG

This multi-signature locking script can be used to embed data, by replacing a subset of the public keys P₁, . . . , Pₙ with other data. A multisignature locking script can be used to embed n−1 data elements, with only one valid public key P. This is written schematically as

[CheckMultisig 1-of-n]=OP_1<P><D₁> . . . <Dₙ₋₁>OP_n OP_CHECKMULTISIG

### Agreements on the Blockchain

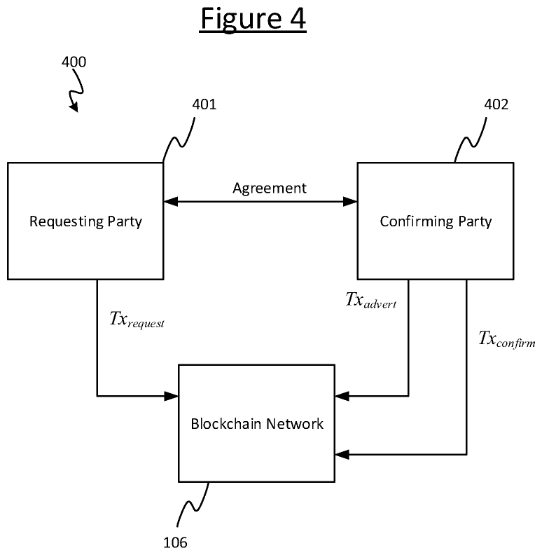

FIG. 4 illustrates an example 400 system for implementing embodiments of the present invention. As shown, the system 400 includes a requesting party 401, a confirming party 402 and the blockchain network 106 (i.e. one or more blockchain nodes 104). According to embodiments, the requesting party 401 is configured to generate a request transaction and submit the request transaction to the blockchain network 106 (or otherwise cause the request transaction to be submitted to the blockchain network 106). The confirming party 402 is configured to generate a confirmation transaction and submit the confirmation transaction to the blockchain network 106 (or otherwise cause the confirmation transaction to be submitted to the blockchain network 106). As also shown in FIG. 4, the confirming party 402 may also generate an advertisement transaction and submit it to the blockchain network 106. In some examples the requesting party 401 and confirming party 402 may communicate using an off-chain communication method.

The requesting party 401 and confirming party 402 may perform some or all of the actions associated with Alice 103a and/or Bob 103b described above. For instance, the requesting party 401 may be equated with Alice 103a and the confirming party 402 may be equated with Bob 103b, or vice versa. In that sense, each of the requesting party 401 and confirming party 402 may operate respective computing equipment 102, upon which runs a respective client application 105. It will be appreciated that any actions described as being performed by the requesting party 401 or confirming party 402 may be performed by their respective client application 105, or more generally by their respective computing equipment 102.

In embodiments, the requesting party 401 desires to enter into an agreement with the confirming party 402. The requesting party 401 wants to ensure that the confirming party 402 agrees to exactly the same agreement as the one desired by the requesting party 401. To do so, the requesting party generates a request transaction. The request transaction is a blockchain transaction. The request transaction comprises one or more inputs and one or more outputs. At least one output (a first output) comprises a hash puzzle that is based on the agreement. More generally, the hash puzzle is based on a data item (a first data item) that represents the agreement. Here, the first data item may encode or otherwise compress the agreement, e.g. the first data item may comprise a hash of at least the agreement (and optionally additional data). In other examples, the first data item may comprise (e.g. be) the agreement.

In some examples, the “agreement” between the two parties may be based on static information, e.g. standard terms and conditions, a non-disclosure agreement, a waiver to be signed by any user, etc. Put another way, the agreement may be generated by just one of the parties.

In other examples, the agreement may be generated by both parties. That is, both the requesting and confirming parties may have each contributed to the agreement, e.g. a negotiated contract, which may have been based on an initial version proposed by either party.

The hash puzzle included in the request transaction is based on the final form of the agreement in either case. The final form of the agreement may be the same as an advertised agreement (discussed in more detail below). Alternatively, the final form may have been the result of mediation, negotiation, etc. by the requesting party 401, the confirming party 402, and/or an independent third party.

The first data item is known to both the requesting party 401 and the confirming party 402. That is, both the requesting party 401 and confirming party 402 have access to the agreement represented by the first data item.

The hash puzzle of the first data item A may take the following form:

[Hash Puzzle H(A)]=OP_SHA256<H(A)>OP_EQUAL

The opcode OP_SHA256 is configured to hash an input using the SHA-256 hash function. In general, the hash puzzle may comprise an opcode configured to hash an input using a different hash function. For instance, the OP_SHA256 opcode in the above hash puzzle may be replaced with any one of OP_RIPEMD160, OP_SHA1, OP_HASH160, OP_HASH256, or any other hashing opcode that may become available.

As mentioned above, when executed alongside an input script of a later transaction, the hash puzzle requires the input script to comprise the first data item A.

The request transaction may comprise an input comprising a signature generated by the requesting party 401, e.g. generated using a private key owned by the requesting party 401. The signature may sign one or more input and/or one or more outputs of the request transaction.

In some examples, the first output of the request transaction may comprise one or more additional hash puzzles. For instance, a hash puzzle based on the subject of the agreement (a second data item) may be included in the first output. Here, the subject of the agreement may take any form, e.g. an image file, video file, audio file, text document, computer code, etc. More generally the second data item may represent content that is to be provided (e.g. purchased or licensed) under the terms of the agreement. The second data item may comprise the content itself, or comprise a hash of at least the content.

Additionally or alternatively, the first output may comprise a hash puzzle based on a third data item that represents an identifier of the requesting party 401. For instance, the identifier may be a public key corresponding to a private key owned by the requesting party 401. The identifier may take a more conventional form, e.g. a name, address, email address, etc. The third data may comprise the identifier, or the third data item may comprise a hash of at least the identifier.

The requesting party 401 may additionally lock the first output to a public key of the confirming party 402 such that, in order to be unlocked, an input attempting to unlock the first output must include a signature generated based on a private key owned by the confirming party 402 that corresponds to the public key.

The request transaction may additionally include one or more data elements. For instance, the request transaction may include one, some or all of the following: a hash of the agreement, a double-hash of the agreement, a hash of the requesting party's identifier, a double-hash of the requesting party's identifier, a hash of the confirming party's identifier, a double-hash of the confirming party's identifier, an indicator (e.g. flag) indicating that the request transaction is a request transaction, and a reference to (e.g. a TxID of) an advertisement transaction (discussed below). Some or all of the data elements may be included in the first output, e.g. using an OP_DROP statement. Some or all of the data elements may be included in a second output. The second output may be an unspendable output, e.g. an OP_RETURN output.

In some examples, the first output may include an additional portion of script that allows the first output to be unlocked in more than one way. For instance, the first output may include an if-else statement (or equivalent). A first branch of the if-else statement may comprise the hash puzzle(s) described above. A second branch may be locked to a public key, e.g. a public key of the requesting party 401 or a public key of the confirming party 402.

For instance, the output locked to the public key of the requesting party 402 may be a P2PK or P2PKH output. In some examples, the second branch may comprise a multi-signature script that is locked to one or more both of the requesting party's public key and the confirming party's public key.

The requesting party 401 transmits the request transaction to one or more blockchain nodes 104. The requesting party 401 may instead transmit the request transaction to another party (e.g. the confirming party 402) for forwarding to one or more blockchain nodes 104. Assuming the request transaction fulfils the requirements of the blockchain protocol for being a valid transaction, the request transaction will be published on the blockchain 150.

The confirming party 402 obtains a reference to the request transaction, e.g. the transaction identifier of the request transaction. The confirming party 402 generates a confirmation transaction. The confirmation transaction comprises one or more inputs and one or more outputs. A first input of the confirmation transaction references the first output of the request transaction. The first input comprises a solution to the hash puzzle based on the first data item. That is, the first input comprises the first data item.

The first input of the confirmation transaction may also comprise one or more additional solutions if the request transaction comprises one or more additional hash puzzles. For instance, the first input of the confirmation transaction may comprise the second data item and/or the third data item.

The first input of the confirmation transaction may also comprise a signature generated by a private key owned by the confirming party 402, e.g. if the first output of the request transaction is locked to a corresponding public key.

The confirmation transaction may comprise a first output locked to a public key of the confirming party. For instance, the output be a P2PK or P2PKH output. The public key may be the same public key that the first output of the request transaction is locked to, but preferably it is a different public key.

The confirming party 402 transmits the request transaction to one or more blockchain nodes 104. The confirming party 402 may instead transmit the request transaction to another party (e.g. the requesting party 401) for forwarding to one or more blockchain nodes 104. Assuming the confirmation transaction fulfils the requirements of the blockchain protocol for being a valid transaction, the request transaction will be published on the blockchain 150 if the first input of the confirmation transaction comprises the data required to unlock the first output of the request transaction.

The confirmation transaction, once published on the blockchain 150, evidences the mutual consent to the agreement by both the requesting party 401 and the confirming party 402. The mutual consent is confirmed in the sense that the confirmation transaction will be published if it includes a solution to the hash puzzle, and in order to so, both the requesting party 401 and confirmation party 402 must have the same first data item, which is generated based on the same agreement.

As discussed above, both the request transaction and the confirmation transaction may include a respective signature generated by the requesting party 401 and the confirming party 402 respectively. That is, the request transaction may include, in an input, a signature that signs some or all of the request transaction. Similarly, the confirmation transaction may include, in an input, a signature that signs some or all of the confirmation transaction.

Preferably, the requesting party's signature signs a message that includes the first output of the request transaction, i.e. the transaction comprising the hash puzzle(s), and the confirming party's signature signs a message that includes the first input of the request transaction, i.e. the input that references and unlocks the first output of the confirmation transaction.

These signatures may be interpreted as signing the agreement itself in analogy to signing a paper copy of an agreement. That is because the message signed by the confirming party's signature, in general, must necessarily also include the first output script of the request transaction. This means that the signatures actually both sign the first output (or at least the locking script of the first output) of the request transaction. See https://wiki.bitcoinsv.io/index.php/OP CHECKSIG for further information. OP_CHECKSIG is an opcode that verifies an ECDSA signature. It takes two inputs from the stack, a public key (on top of the stack) and an ECDSA signature in its DER_CANONISED format concatenated with sighash flags. It outputs true or false on the stack based on whether the signature check passes or fails.

Note that the data in the first input of the confirmation transaction, e.g. H(IP) or H(LA), are not in general signed by the confirming party's signature since a signature cannot sign itself, i.e. a signature does not normally sign the input script that the signature is contained in.

This concept effectively forces both of the two parties to sign (at least partially) the same message, and the part of the message they both sign includes the representation of the agreement.

In some examples, the first output of the request transaction may comprise one or more opcodes configured to separate portions of the locking script. One such opcode is OP_CODESEPERATOR (OCS). See e.g. https://wiki.bitcoinsv.io/index.php/OP CODESEPARATOR. OCSs can be used to allow the confirming party 402 to select only the agreement (or the representation of the agreement, e.g. the double-hash of the first data item or the whole hash puzzle) from the first output of the request transaction to sign. For instance, the hash puzzle based on the first data item may be placed between an OCS opcode and an OP_CHECKSIG opcode. This enables the data between the OCS opcode and the OP_CHECKSIG opcode to be signed by the signature included in the first input of the confirmation transaction.

Two example locking scripts that may be included in the first output of the request transaction are provided below. In the first example, the OP_CODESEPARATOR is used to help a third party only sign part of the previous locking script. In the alternative example, the locking script allows the confirming party to only sign a part of the transaction of interest to them.

Locking script (in request transaction):

### OP_CHECKSIGVERIFY <H(LA)><OP_DROP>OP_CODESEPARATOR OP_CHECKSIG

Unlocking script (in confirming transaction):

### <Sig B><PK B><Sig A><PK A>

Explanation:
PK A may be the public key of the confirming party
<Sig A>signs over a message that includes “<H(LA)><OP_DROP>OP_CODESEPARATOR OP_CHECKSIG”
PK B may be a third party's public key, e.g. a copyright lawyer or witness,
<Sig B>signs over a message that does not include the entirety of the script in quotes above
OP_CODESEPARATOR ensures that <Sig B>doesn't need to sign any of the previous locking script to the left hand side of OP_CODESEPARATOR

Or, alternatively:

Locking script (in request transaction):

### OP_CHECKSIGVERIFY <OTHER DATA><OP_DROP>OP_CODESEPARATOR OP_CHECKSIG <H(LA)>

Unlocking script (in confirming transaction):

### <Sig A><PK A><Sig B><PK B>Explanation:

This is similar to the first scenario, but the order of the signers has been switched, and the locking script includes some <OTHER DATA> that the confirming party doesn't need to sign.
The <OTHER DATA>may be, e.g. a witness declaration that needs to be signed by the witness but not the chief signatory (i.e. the confirming party).
<Sig B>(signature by third party e.g. copyright lawyer, witness etc.) signs the entire script “OP_CHECKSIGVERIFY <OTHER DATA><OP_DROP>OP_CODESEPARATOR OP_CHECKSIG <H(LA)>” as taken from the request transaction's output.
<Sig A>(signature by the confirming party) signs a message that only includes the “OP_CHECKSIG <H(LA)>” part of the request output script, which includes the bit of interest, the <H(LA)>, but excludes <OTHER DATA>.

In some embodiments, the requesting party 401 may generate a refund (or cancel) transaction to unlock the first output of the request transaction. This has the effect of removing the first output from the set of unspent transaction outputs (UTXOs) on the blockchains. It also has the effect of preventing the confirming party 402 from unlocking the first output by solving the hash puzzle.

If the first output of the request transaction comprises a branch of locking script that is locked to a public key of the requesting party 401, a first input of the refund transaction may comprise a signature generated using a corresponding private key. If the first output of the request transaction comprises a branch of locking script that is locked to multiple public keys (e.g. a multi-signature script), the first input of the refund transaction may comprise multiple signatures, e.g. one generated using a private key owned by the requesting party 401 and one generated using a private key owned by the confirming party 402.

In some examples, the requesting party 401 may generate a refund transaction template that comprises an input that references the first output of the request transaction, and then transmit the refund transaction to the confirming party 402. In turn, the confirming party may add a signature to the first input of the refund transaction and refund the signed transaction to the request transaction. The requesting party 401 may then include a signature in the first input of the request transaction. When the requesting party 401 wants to cancel the request for the agreement, the requesting party 401 transmits the completed refund transaction to the blockchain network 106, or to another party for forwarding to the blockchain network 106.

As an optional feature, the refund transaction may comprise a time restriction (or time lock). The time restriction is configured to prevent the refund transaction from being published on the blockchain 150 until a specified period of time has passed. For instance, the time restriction may set a time (e.g. measured in UNIX time) before which the refund transaction cannot be published. Alternatively, the time restriction may set a block (e.g. measured in block height) before which the refund transaction cannot be published.

Similarly, the confirming party 402 may generate a revocation transaction to unlock the first output of the confirmation transaction. If the first output of the confirmation transaction is locked to a public key of the confirming party 402, a first input of the revocation transaction may comprise a signature generated using a corresponding private key. The revocation transaction is interpreted as a revocation of the agreement between the requesting party 401 and the confirming party 402. Therefore when the confirming party 402 wants to revoke the agreement, the confirming party 402 transmits the revocation transaction to the blockchain network 106, or to another party for forwarding to the blockchain network 106.

In some embodiments, the confirming party 402 may generate an advertisement transaction, e.g. in order to advertise the agreement. The advertisement transaction has one or more input and one or more outputs. At least a first one of the inputs comprises a signature generated using a private key owned by the confirming party 402. As mentioned above, the confirming party 402 may use the same private key for every signature that it generates, or the confirming party 402 may use a different private key for one or more of the signatures that it generates. The advertisement transaction also includes a first output that comprises a representation of the agreement and/or an encrypted version of the agreement.

The representation of the agreement may be a hash of the agreement or a double-hash of the agreement. The agreement may be otherwise represented. The encrypted version may be generated by encrypting the agreement with a public key owned by the confirming party 402, or with a public key owned by the requesting party 401. In some examples, the agreement may be encrypted with a key owned by both parties, e.g. a symmetric key. In some examples, the output may comprise the agreement itself.

The advertisement transaction may comprise one or more additional inputs, each comprising a signature generated using a private key owned by a respective party, e.g. additional parties to the advertised agreement.

The advertisement transaction may comprise an indicator (e.g. a flag) that indicates that the advertisement transaction is an advertisement of the agreement. The indicator may be included in the first output, or a different output of the advertisement transaction. The first output (or a different output) of the advertisement transaction may comprise a representation (e.g. a hash or double-hash) and/or encrypted version of the subject of the agreement. In some examples, the output may comprise the subject of the agreement itself.

The advertisement transaction may comprise an output (e.g. the first output or a different, second output) that is locked to a public key of the confirming party 402. For instance, the output locked to the public key of the confirming party 402 may be a P2PK or P2PKH output.

In order to advertise the agreement, the confirming party 402 transmits the advertisement transaction to the blockchain network 106, or to another party for forwarding to the blockchain network 106.

Additionally or alternatively, the confirming party 402 may advertise the agreement (or potential agreement) off-chain, i.e. without using the blockchain network 106. For instance, the confirming party 402 may send the (potential) agreement directly to the requesting party 401, e.g. via a side channel 107. As another example, the confirming party 402 may advertise the (potential) agreement on a website, e.g. a company website, social media site, etc. It is also not excluded that the confirming party 402 may inform the requesting party 401 about the agreement face-to-face, or over the phone.

Regardless of how the agreement is advertised, the advertised agreement may or may not be the same as the final agreement on which the hash puzzle is based. For instance, the advertised agreement included in the advertisement transaction may differ from the ‘final agreement’ used in the locking script of request transaction and the unlocking script of the confirmation transaction.

For instance, the final agreement may be based on an initial agreement used as a starting point, and may have gone through one or more rounds of amendments e.g.:

Final agreement=agreement+negotiated additions

Or, alternatively:

$$\begin{matrix}Final agreement = agreement + negotiated additions - negotiated removals \\ = agreement + negotiated changes\end{matrix}$$

The hash puzzle is important for enforcing mutual understanding of whatever the final form of the agreement is at the point it is requested and confirmed, rather than advertised.

The confirming party 402 may want to update the advertised agreement, i.e. to change one or more terms of the agreement. To do so, the confirming party 402 generates an update transaction that comprises an input that references and unlocks the second output of the advertisement transaction. The input of the update transaction may therefore comprise a signature generated using a private key corresponding to the public key to which the output of the advertisement transaction is locked. The update transaction also includes an output comprising a representation and/or encrypted version of the updated agreement. The update transaction may comprise an indicator (e.g. a flag) that indicates that the update transaction is an advertisement of an updated agreement. In some examples, the output may comprise the updated agreement. In order to update the agreement, the confirming party 402 transmits the update transaction to the blockchain network 106, or to another party for forwarding to the blockchain network 106.

Note that whilst the example of a hash puzzle has been used in the embodiments above, in general any reference to “hash puzzle” may be replaced with “cryptographic puzzle”. That is, a hash puzzle is an example of a cryptographic puzzle, and embodiments of the present invention may use any form of a cryptographic puzzle. In general the cryptographic puzzle may comprise any one-way function. For instance, as set out above, the cryptographic puzzle may be a hash puzzle that comprises a hash function.

In other examples, the cryptographic puzzle may be an r-puzzle., or an r-challenge. R-puzzles are described in detail in PCT/IB2020/053807, to which the reader is referred. A brief description of r-puzzles will now be provided.

An r-puzzle is based on a reference value corresponding to the r-part of an ECDSA signature as the basis of the challenge (i.e. puzzle). The reference value is included in the locking script of the request transaction as a challenge requiring a confirmation transaction to include a signature comprising the specified r-part (i.e. in the unlocking script of the confirmation transaction) in order to unlock the request transaction. By providing a solution to the r-puzzle in the confirmation transaction, this proves that the confirming party must have known the corresponding ephemeral key k, but without the need to reveal k in the confirmation transaction. Thus k can be used as an ephemeral private key, and r acts like a corresponding ephemeral public key.

Put another way, an r-puzzle is a knowledge proof based on an elliptic curve digital signature algorithm, ECDSA, verification function. The locking script of the request transaction comprises an element specifying a reference instance of an r-part of a first ECDSA signature. The confirmation transaction includes information comprising at least an s-part of the first ECDSA signature, and a first public key, wherein the first ECDSA signature signs a message based on a first private key corresponding to the first public key, the message being a part of the confirmation transaction. The request transaction will be unlocked on condition that: the ECDSA verification function, as applied to the first ECDSA signature, verifies that the s-part received in the confirmation transaction corresponds to the reference instance of the r-part specified by the request transaction, given the message received in the second confirmation transaction and the obtained first public key.

The element included request transaction may be the reference instance of the r-part itself, or may be a transformation thereof, e.g. hash of a component comprising the r-part (where the hashed component could just be equal to the r-part itself or could be concatenated with another data value d, for example). Note therefore that “specified” in the context does not necessarily mean includes an explicit value of (though that is certainly one possible implementation). More generally, it can refer to any element equal to or derived from a reference instance of the r-part (e.g. a hash of it) that enables to check whether the submitted instance of the s-part validly corresponds to the reference instance according to the ECDSA verification algorithm.

A solution to the “r-puzzle” proves that the confirming party must have known the ephemeral key k (it is not feasible that the solution could have been provided without knowledge of k). The ephemeral key may be generated based on, or otherwise represent the agreement.

The functionality of a hash puzzle can be emulated by exploiting the r-part in an ECDSA signature, which may be an ephemeral random value. The ECDSA signature consists of two main parts, r and s. As is familiar to the skilled person, r=[k·G]ₓ. In place of a conventional hash puzzle h=H(d), the intractability of inverting elliptic curve addition can form an analogous puzzle called herein an r-puzzle. To solve the puzzle, one would need to obtain the solution value k, where k is the ephemeral key corresponding to r.

With conventional hash puzzles, the risk is revealing d onto the blockchain when solving the puzzle. However, with the r-puzzle, k is never revealed. Instead r is revealed and from r along with the signature, the knowledge of k can be proved.

To emulate hash puzzle functionality, the creator of the r-puzzle may first hash some other pre-image data to get the value k, since k must be a fixed size whereas the pre-image data of a hash puzzle can be any length (and one property of a hash function is that it outputs a value of a fixed length regardless of the length of the input data). For example, if using private/ephemeral keys that are 256 bits long, then the pre-image data to the r-puzzle should be hashed to get k. Alternatively however, some suitable-length value of k could just be selected and used as the secret value directly in its own right (i.e. there is no need to derive it from some other, preceding pre-image).

In the scripting language, the OP_CHECKSIG opcode requires a signature and a public key on the stack (with the public key on the top of the stack and the signature immediately below it). For the r-puzzle, the script is configured to check that the r value in the signature provided is the same one used for the r-puzzle challenge. In other words, the script will not only check that the signature is valid on the public key (through OP_CHECKSIG), it will also make sure that the signature is created using the r value of the r-puzzle, which is to be published on the blockchain beforehand.

Some example implementations of an r-puzzle are now discussed. In each case the prover, e.g. Bob, has created a signature (r, s) by signing a part of Tx₂. A signature of this form may also sometimes be referred to as “sig”. In the context of cryptographic signatures, the signed part is also called the “message” (m). The signed part (message) m includes at least an output of Tx₂ which will lock the resulting payment to Bob. If there is more than one output, m may comprise some or all of the outputs. m may also include other parts such as the locktime if used. However it will typically exclude the unlocking script itself (and of course must at least exclude the signature itself). The part of Tx₂ to be signed as the message m could be set by Sighash, or could be a default, or a fixed feature of the protocol.

In a simple implementation, the locking script in Tx₁ comprises a reference instance or the r-part, labelled here r′. In this method, the unlocking script in Tx₂ need only contain at least the s-part (s) of Bob's signature. It may also include the public key P corresponding to the private key V which Bob used to sign m. The locking script of Tx₁ is configured so as, when run by the script engine at a node 104, to take s and P from the unlocking script of Tx₂ and perform the following operations:

I) R′=H_{sig}(m)s⁻¹·G+r′s⁻¹·P, and

II) check [R′]ₓ=r′,

where r′ is taken from the locking script of Tx₁, and s and m are taken from the unlocking script of Tx₂. Bob's public Key P may also be taken from the unlocking script Tx₂, or it may be known by other means. H_{sig} is a hash function that was used to hash m in generating the first ECDSA signature. It may be any form of hash function. Whatever form it takes, the form (type) of this hash function may be assumed to be predetermined and known at both ends. G is a fixed, publicly known vector value.

The locking script is configured to return the result of “true” on condition that said check is true, but to return a result of “false” otherwise. In the UTXO case, a true (i.e. successful) outcome of running the locking together with the unlocking script is a requirement for validity of the transaction. Thus the validity of the Tx₂ can be used as a proxy for the outcome of the r-puzzle. Or put another way, the validity of Tx₂ is conditional on providing the solution to the r-puzzle. I.e. if Bob does not pass the r-puzzle, his transaction Tx₂ will not be propagated over the network 106 nor recorded in the blockchain 150 (and any payment defined in the output of Tx₁ will not be redeemed).

Whilst this example may be simplest in a mathematical sense, this does not necessarily mean it is simplest to integrate with any given node protocol or scripting language. If the spender only provides <s> and <P> in the unlocking script as opposed to <r, s> and <P>, then the script must account for this. Operations I)-II) are not the operations of a standard Checksig type opcode. The OP_CHECKSIG op-code expects the signature to be in DER format so if only the <s> value is provided in the unlocking script then there will need to be some additional op-codes in the locking script (OP_CAT to concatenate etc.) in order to produce a valid signature in DER format. Note also: it is not essential to include P in Tx₂ in all possible embodiments. In fact, from knowledge of the message m and (r, s), or in this case (r′, s), it is possible to compute two possible values P and −P of the public key (but not to know which is which). Two verifications can then be used identify which is the correct one, or alternatively a one bit flag can be included in Tx₂ to signal which of the two possible solutions to use.

In other examples, the cryptographic puzzle may be a private key puzzle. Private key puzzles are described in detail in WO2020065460, to which the reader is referred. A brief description of private key puzzles will now be provided.

A private key puzzle is a function in a locking script that will evaluate to TRUE if an input is provided that exposes the private key S₁ of a given public key P₁. A puzzle of this form is desirable as it allows one to utilise the algebraic properties of Elliptic Curve Cryptography (ECC) public/private keypairs.

Consider an ECC private key S₁ ϵ [symbol] and corresponding public key P₁, where n is the order of the elliptic curve base point G. The public and private keys are related by the equation

P₁=S₁·G,

where the operator “·” denotes elliptic curve point multiplication. Given P₁ it is a computationally hard problem to determine S₁ even if the elliptic curve parameters are known. In effect there is a one-way deterministic function

S₁ [symbol] P₁.

The equivalent of a hash puzzle can be constructed for a public/private key pair. This private key puzzle is a function <Solve P₁> that will evaluate to TRUE if acting on the corresponding private key <S₁>. That is

<S₁><Solve P₁>=TRUE.

This requires an operator (e.g. opcode) that performs elliptic curve point multiplication. Such an operated is labelled “OP_ECMULT” below. This means that a point on an elliptic curve, for example the generator point G, is multiplied by a positive integer, for example S₁ϵ [symbol] . That is

<S₁><G>OP_ECMULT=<P₁>.

In this case a private key puzzle is given by:

<Solve P₁>=<G>OP_ECMULT<P₁>OP_EQUALVERIFY.

Although no single opcode currently exists in some scripting languages (e.g. Script) that can perform the function of OP_ECMULT, it would be trivial to create and include such a function. In addition, those languages include all the operators that are required to perform elliptic curve multiplication within Script, i.e. to construct OP_ECMULT using other operators.

It can be seen that if the private key is generated based on, or represents the agreement, then both the confirming party and requesting party require the same knowledge of the agreement in order for the private key puzzle to be successfully solved.

### Blockchain Licensing Protocol

The present invention may be used to implement a licensing protocol using the blockchain 150. The blockchain licensing protocol (BLP) comprises two elements that are combined by the protocol to provide all of the required functionality of a system for handling license agreements (LAs) in a distributed manner. These two elements are bilateral hash puzzle agreements, and a system of different transaction types. Bilateral hash puzzle agreements facilitate the agreement of the terms of a LA between multiple parties by evidencing each parties consent in the form of a hash puzzle. The system of transaction types can be used to implement bilateral hash puzzle agreements over a blockchain network 106, and in such a way that the system of transactions can describe the core functions associated with issuance and management of license agreements.

Hash puzzles are normally used as a knowledge proof to enforce a party to prove that they have knowledge of a secret preimage or data. On the other hand, the present invention uses hash puzzles as a consent proof to ensure that two parties express mutual consent and understanding of a public preimage or data. In the context of the BLP, this public preimage is the terms of the license agreement itself.

In typical hash puzzles, the key property that is utilised is the pre-image resistance of hash functions. This is because, for a hash puzzle locking script of the form

[Hash Puzzle H(X)]32 OP_SHA256<H(X)>OP_EQUAL

it is intended that the preimage X will remain secret until the point at which the spender reveals it as part of an unlocking script.

In order for such a locking script to be cryptographically secure, one relies on the pre-image resistance of the hash function H; that is given H(X) it should be computationally infeasible to find X. This ensures that the challenge can be broadcasted publicly without comprising the secret X, and only the desired spending party can redeem funds locked in this way once they obtain the value X.

Conversely, in a bilateral hash puzzle agreement the key property that is utilised is that of second pre-image resistance. That is, for a given challenge H(X) and knowledge of X, it should be computationally infeasible to find X′ such that

H(X′)=H(X) and X′≠X

For a bilateral hash puzzle agreement (BHPA) between Alice and Bob, it is intended that one of the two parties will construct a locking script comprising

[Hash Puzzle H(A)]=OP_SHA256<H(A)>OP_EQUAL,

where A represents the terms of an agreement and the entire data of A can be made public.

This means that the agreement details can be known by both parties ahead of time. The construction and publishing of a transaction comprising this locking script is to be interpreted as Alice creating an offer to the Bob. The second party Bob can then meet this challenge, with an unlocking script comprising A, as a way to express that they accept the exact offer made by Alice. The key difference is that, because A represents the terms of an agreement, it should be known to both parties in advance, and therefore does not to be treated as a secret. The terms may even be adapted from a public resource, and thus A could be public knowledge to third parties external to the two parties attempting to reach an agreement.

Therefore, rather than relying on preimage resistance to prevent the obtainment of A by an unintended third party, the BLP relies on second preimage resistance to ensure that Bob can only agree to the terms set out by Alice if he does indeed wish to accept them.

The phrase proof of consent is used to express the motivation for re-purposing simple hash puzzles to implement bilateral hash puzzle agreements. A BHPA is an effective means for two parties to express their mutual consent on a single article of data: the preimage of the hash. In other words, if Bob sees Alice's offer conveyed as challenge [Hash Puzzle H(A)], then Bob can only express acceptance of the offer Alice has made as he cannot generate some alternative agreement details A′ such that

H(A′)=H(A) and A′≠A

both hold simultaneously.

This subtly has two primary advantages for implementing a bilateral agreement using hash puzzles:
1. If Alice makes an offer A, based on terms of her choosing, it is impossible for her to later become inadvertently obligated to an alternative offer A′, based on terms of Bob's choosing.
2. If Bob makes the terms of an offer A, that he is willing to accept, publicly available then he may automate the process of confirming his acceptance of offers made by many first parties such as Alice.

If Bob automates such that only offers that satisfy [Hash Puzzle H(A)] are accepted, then he does not risk inadvertently automatically agreeing to alternative conditions A′.

The BLP utilises a blockchain 150 to implement BHPAs in such a way that the proof of consent that is achieved by them is both immutably recorded on a public ledger and able to be included as part of the spending conditions required to allocate digital assets associated with an exchange of value under the terms of license agreements to which both a licensee and licensor prove their consent.

The next section will show how bilateral hash puzzle agreements can be integrated into a system of multiple blockchain transactions in order to facilitate a powerful license-agreement platform that can be applied to many use cases, including the onward licensing and commercialisation of IP.

The BLP also makes use of some additional benefits involved with using a double-hash of the given preimage in a BHPA. A BHPA challenge takes the following form:

[Hash Puzzle H²(A)]=OP_SHA256<H²(A)>OP_EQUAL,

where A is the data of interest (e.g. a license agreement). These challenges are useful in reducing the storage burden related with large agreements or documents, as they can be satisfied by providing the hash of the preimage H(A).

Assuming that both parties have access to A, this has the same effect in achieving a proof of consent to the terms specified in A, but without requiring the parties to store and broadcast the full data to the blockchain.

The BLP specifies five configurable blockchain transactions which can be considered ‘action types’ for the BLP. These transactions can be mapped to five functions of the BLP that are pertinent to the majority of scenarios involving license agreements (LAs). These functions are as follows:
Advertisement of license terms,
Request for purchase/license,
Confirmation of purchase/license,
Update of license terms, and
Refund.

The detailed responsibilities of each transaction type in achieving their respective function is described in the table below. It will be appreciated that not all of the transaction types are essential. In the example below, the buyer is equivalent to the requesting party 401 and the copyright authority is equivalent to the confirming party 402. Note that this need not be the case in all examples. That is the confirming party 402 (the party that generates the confirmation transaction) does not need to be the same party that owns the IP. Also note that the term “copyright authority” is used merely as a label and does not necessarily mean that the party performing the actions associated with the copyright authority has to own the copyright to the IP.

Advertisement transaction (T_{A})

The advertisement transaction is used to provide documentation of the IP and the licensing agreement for the IP. The IP's raw data itself may be stored in the transaction or, if preferred, an encrypted version of the IP. However it is not necessary (or desirable in some contexts) to include the raw or encrypted form of the IP or LA in in the transaction. Instead, a unique identifier of the IP/LA be stored in the transaction. This identifier, as previously described, could be represented as double hash of the IP's raw content. The double hash can be used (instead of a single hash) due to the fact that in some instances a party must provide in unlocking scripts the preimage of the IP/LA in order to confirm that they are acting in knowledge of the exact IP/LA that they should. If the unique identifier of the IP/LA was the hash of the actual IP/LA, then provision on the blockchain of the preimage of the hash would be the provision of the ‘raw’ IP/LA. This, as previously mentioned, may not be desirable. Using the double hash means that providing the preimage is providing the hash, something that does not reveal the raw IP/LA.

This transaction is expected to be signed by at least one authority who is known to have legal authority over the IP. This could be the creator of the IP himself, or a third-party Copyright Authority (CA) that manages the licensing of the IP on behalf of others, e.g. a music label.

### Purchase Transaction (Tₚ)

The purchase transaction (also referred to as the request transaction) is the transaction where the entity who wants to license the IP assigns their tokens to the specified owner/copyright authority of the IP under the conditions of the advertised licensing agreement. The request transaction contains a reference to the IP it would like to license. Note that the request transaction does not automatically grant the user license to the IP. It is a formal representation of ‘the request to license the IP’ and an escrow, by the buyer, of the tokens that were advertised as the cost of the license. The CA still needs to accept the license before the license agreement is considered binding.

### Confirmation Transaction (T_{C})

The confirmation transaction is where the copyright authority of the IP accepts the requestor's tokens and formally grants the interested party the right to use the IP as per the terms of the referenced licensing agreement.

### Update Transaction (T_{U})

The update transaction is intended for use where there needs to be an update to the existing licensing agreement. For a variety of reason (closing loopholes, satisfying regulations, updating costs, etc) the terms outlined in the licensing agreement may need to be changed for correctional. The update transaction spends an executable output of an existing advertisement transaction and itself contains the LA and IP data that an advertisement transaction would have. In other words, an update transaction can be seen as ‘an advertisement transaction that spends the executable output of an existing advertisement/update transaction’. After the update transaction spends the output of an advertisement transaction, the terms and conditions of that previous advertisement transaction may no longer be considered valid by the CA or potential licensees.

### Refund Transaction (T_{R})

The refund transaction is a transaction where the party which expresses interest in licensing the IP, via a request transaction, can have their funds refunded if the CA does not confirm, before a specified point in time, that the interested party has been granted the license. The CA would have ‘confirmed’ by spending the executable output of the request transaction. The refund transaction is optional but recommended.

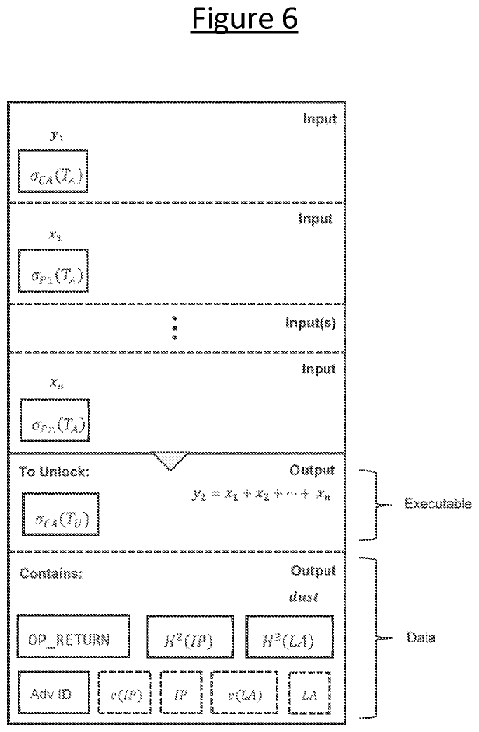

FIG. 6 schematically illustrates an example advertisement Transaction T_{A} especially as it relates to their inputs and outputs. At least one input of the transaction is signed by the person who is accepted as the legitimate owner/manager of the rights to the IP. This person is termed the Copyright Authority (CA). There may be other signers to the transaction. These would be signed inputs from other stakeholders in the IP who see fit that they also give approval to the Licensing Agreement for the IP the transaction is promoting. These would be the stakeholders {Pᵢ:i ϵ[1, n]}.

There are two outputs shown in the advertisement transaction. Reference is first made to the OP_RETURN output representation of what is being agreed upon is essentially the pair ( [symbol] H²(IP) [symbol] , [symbol] H²(LA [symbol] ); these pieces of data are stored in the OP_RETURN output script. Note that the script for an OP_RETURN output is not ‘processed’ as a component of successful execution of script, hence the script that follows OP_RETURN can be utilised for including data in a transaction. Another item included in the OP_RETURN script is an advertisement identifier shown in FIG. 6 as [symbol] Adv ID [symbol] . This is an identifier chosen and publicised by the copyright authority as a marker that would inform any existing or potential stakeholder that the transaction represents the promotion and/or representation of an IP and its license agreement. Interested parties can parse the blockchain 150 for transactions that contain this identifier in order to find these specialised ‘advertising’ transactions. In addition to the three pieces of data [symbol] H²(IP) [symbol] , (H²(LA [symbol] ), and [symbol] Adv ID [symbol] , there may be other pieces of data that are optionally included. Several are shown in FIG. 6. Shown in the figure are:
IP: This is the raw data of the actual IP being licensed. Reasons for its exclusion may be for privacy concerns or space-saving concerns. Where the raw IP (or LA) itself is not present on the blockchain 150, it is expected that the raw files would be accessible ‘offline’ as is deemed desirable.
e(IP): Where one doesn't want to reveal the IP itself on the blockchain 150, an encrypted version e(IP) may be placed in the blockchain 150 instead. Restrictions would be placed on who are able to decrypt the IP.
LA: The raw Licensing Agreement that governs the IP can also be included in the transaction.
e(LA): If preferred, an encrypted version of the LA may be included in the blockchain 150.
Additional information can be included in the OP_RETURN.

The second output (termed the active output) is where the digital assets from the advertisement transaction's inputs are ‘sent’. To spend this output requires the signature of the copyright authority. This signature is shown as σ_{CA}(T_{U}) where σ_{CA} represents a digital signature created by the CA and the T_{U} (an update transaction) is what is being signed. The advertisement transaction assigns the digital assets to him/herself, i.e. so that the CA can assign its output whenever they want. The existence of this allows for the CA to revoke or update the LA. By treating the unspent output (UTXO) of the advertisement transaction as an active valid LA (via a mutual understanding by all participants of the licensing service), the CA is able to revoke or update the transaction by spending the output of the active output. A simple revocation is the spending of the advertisement transaction's output signalling that the LA is no longer considered valid for the referenced IP. Whereas an update is where the CA utilises that UTXO as the CA's input to a new advertisement transaction; the new advertisement transaction is expected to contain an updated LA (H²(LA_{v2.0})). The ‘update’ both revokes and updates the IP's existing licensing agreement. Note that (unless there is a legal agreement to do so) the revocation or updating of the LA by the CA does not automatically make previous ‘purchases of that version of the LA.

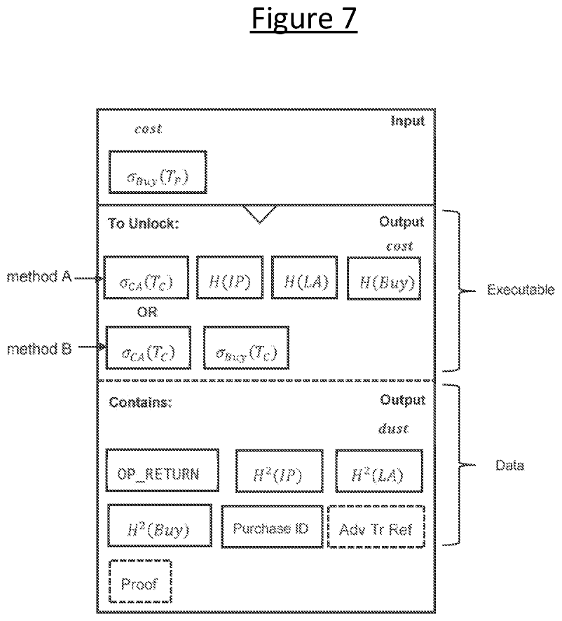

FIG. 7 illustrates an example purchase (or request) transaction. The purchase transaction Tₚ is the transaction that one who is interested in buying/licensing the IP utilises to assign the digital assets required towards its purchase. The purchase transaction has at least one input, as shown in FIG. 7 that includes a signature of the requestor. This digital signature σ_{Buy}(Tₚ) signs the purchase transaction. Similar to the advertisement transaction, the purchase transaction requires storage of data within the transaction. In this example, the data is stored in an OP_RETURN output. The data includes:
H²(IP): This is the unique identifier for the IP/commodity that the buyer is interested in, expressed as the double-hash of the IP/commodity to be purchased.
H²(LA): This is a double-hash of the relevant LA.
H²(Buy): This is a double-hash of the identifier of the buyer. The ID could be the buyer's public key or any other formal identification.

Similar to the advertisement transaction, the OP_RETURN script includes a purchase identifier [symbol] Purchase ID [symbol] . This is a publicised agreed-upon identifier that would inform any existing licensee or licensor that this is a transaction that represents a party's formal interest in purchasing a license to the IP/commodity. Another item in the OP_RETURN script is an advertisement identifier shown in FIG. 7 as [symbol] Adv ID [symbol] . This is an identifier chosen and publicised by the copyright authority as a marker that would inform any existing or potential stakeholder that the transaction represents the promotion and/or representation of an IP and its LA. Interested parties can parse the blockchain 150 for transactions that contain this identifier in order to find these specialised ‘advertising’ transactions.

Furthermore, there could be other miscellaneous and/or optional data included. The Adv Tr Ref is an example of such and is the hash of the blockchain advertisement transaction that promoted or ‘housed’ the IP and its LA of interest. Another example of applicable but optional data for inclusion is the proof of accomplishment’, represented in the figure as [symbol] Proof [symbol] . The acquisition of a license may require that the buyer have accomplished something. e.g. a driver passing their driving test. The proof could be in the form of a signature or certificate created by a trusted external party representing the accomplishment.

The second output of the purchase transaction contains the script that needs to be successfully executed in order to formally confirm that the buyer is granted the license to the IP. The buyer constructs this script such that there are two methods for the script to be successfully executed.

The first (Method A) is where a successful assignor of the digital asset locked by the output (expected to be the CA) must provide the CA's signature, the hash of the IP (H(IP)), the hash of the Licensing Agreement (H(LA)), and the hash of the buyer's identifier (H(Buy)). If the CA were to include these four (4) pieces of data in the spending script this acts as formal confirmation that the CA licensing the stated IP, under the stated terms and conditions of the LA, to that specific individual/institution.

The second method (Method B) requires the signature of both the CA and the buyer. The purpose of this method is for the possibility of incorporating the use of a refund transaction. The refund transaction is where the buyer may direct the committed digital assets back to him/herself, e.g. after a given time has elapsed. The buyer ensures that the refund transaction is signed by at least the CA before the buyer submits the purchase transaction to the blockchain 150.

The importance of this transaction Tₚ is that its spendable output sets up a bilateral hash puzzle agreement (BHPA) to be satisfied by a buyer who must provide the license agreement (or its respective hash). In effect, this transaction is the ‘first side’ of the BHPA, which provides proof that the licensor (CA) consents to the terms of the agreement.

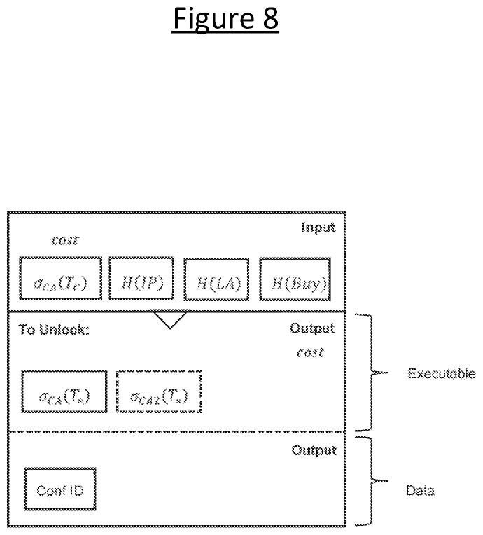

FIG. 8 illustrates an example confirmation transaction. The confirmation transaction is the transaction where the CA confirms that they are indeed granting the license to the IP to the buyer. It confirms this by successfully spending the executable output of the purchase transaction. This requires the CA to provide his signature σ_{CA}(T_{C}), the hash of the IP H(IP), the hash of the license agreement H(LA), and the hash of the buyer's ID H(Buy). The CA decides where any incoming digital assets are assigned.

Like the advertisement and purchase transactions, the confirmation transaction may include an identifier labelled as (Conf ID) that signifies to interested parties the transaction is a confirmation transaction of the BLP. In addition, in scenarios where the IP/commodity is digital and may be protected by encryption, the CA may at this point provide the decryption key to the buyer. In certain implementations, it may also be desirable to store either or both of: (i) the encrypted data, (ii) the encryption/decryption keys on the blockchain, the location of which may also be referenced by the transactions in the BLP.

Where revocation is factored into the BLP, the executable output of the confirmation transaction being unassigned may signify that the license is still active. Where the output is unassigned, the license would be interpreted as being active. While some implementations may afford the CA the sole authority in spending the executable output of the confirmation transaction, in some instances the parties may see fit that the signatures of multiple parties be necessary in order to revoke the buyer's license. These additional signatures are represented in FIG. 8 by the signature σ_{CA2}(T*), where T* represents a subsequent transaction spending the spendable output of T_{C}.

The importance of this transaction T_{C} is that its input satisfies the BHPA by providing either the license agreement or its hash. In effect, this is the ‘second side’ of the BHPA, which provides proof the buyer consents to the terms of the agreement.

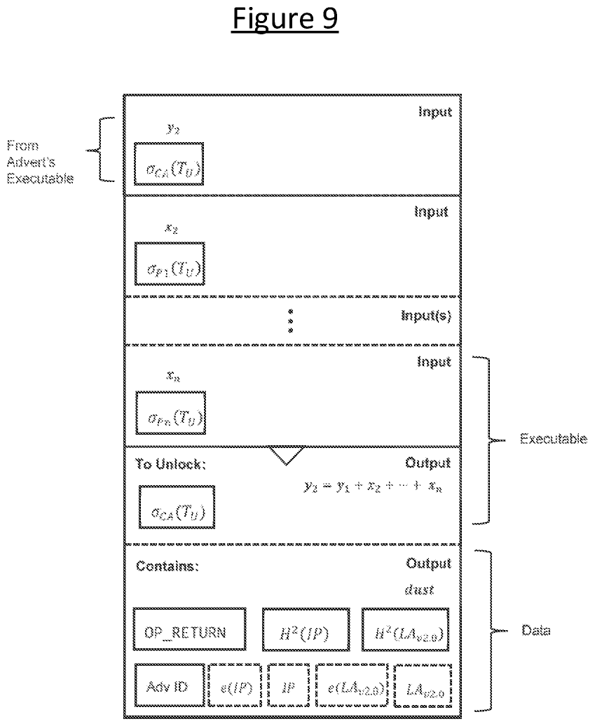

FIG. 9 illustrates an example update transaction. The update transaction is used to provide two functions; it can be used to revoke a deprecated or obsolete previous version of the license agreement, and it can also be used to establish an updated version of the agreement (LA_{v2.0}) to replace the previous version. The update transaction is characterised mainly by the fact that it unlocks the executable output of a previous advertisement transaction. An update transaction can be interpreted as a version of an advertisement transaction that possesses the key characteristic that the input (of the update transaction) that is signed by the CA is from the ‘executable’ output of a previous advertisement/update transaction.

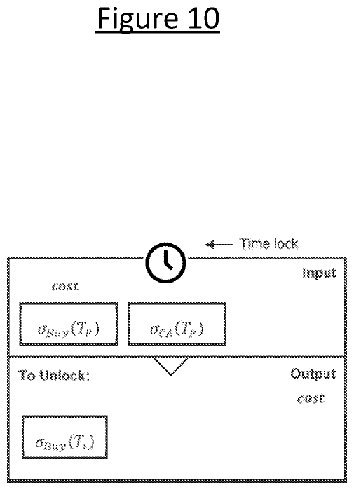

FIG. 10 illustrates an example refund transaction. The refund transaction is the transaction that returns the funds from the purchase transaction to the buyer. This is where the CA fails to confirm or grant the license (i.e. spending the executable output of the purchase transaction) before a specified time. If this time is expired the refund transaction can be successfully submitted to the blockchain 150. The time restriction on the successful submission of the refund transaction may be enabled by assigning a value s to the nLockTime field of the blockchain transaction. nLockTime is a transaction parameter that allows a transaction to only be executable after a specified time has passed. The value s is absolute value and is specified in either UNIX time or block height.

Whilst not illustrated, a sixth transaction which may be included in the design of the BLP is that of a revocation transaction T_{R}. This transaction is utilised where the IP administrators or regulators deem it necessary to withdraw the license previously granted to the buyer. The need for revocation of this license may be due to a predetermined time period having expired or the buyer having violated one or more aspects of the terms and agreements specified by the LA.

The revocation may be accomplished in a variety of ways. An example of an implementation is where an output of the confirmation transaction is utilised to represent whether the license has been revoked or not. If the stated output is spent, then the buyer's license is considered revoked. If the output remains unspent then the license is considered valid. In this approach the CA who authors and signs the confirmation transaction and is entrusted to adjudicate the revocation fairly. For additional credibility to the revocation, the assigning of the output may be designed to require signatures from other trusted authority or regulatory bodies.

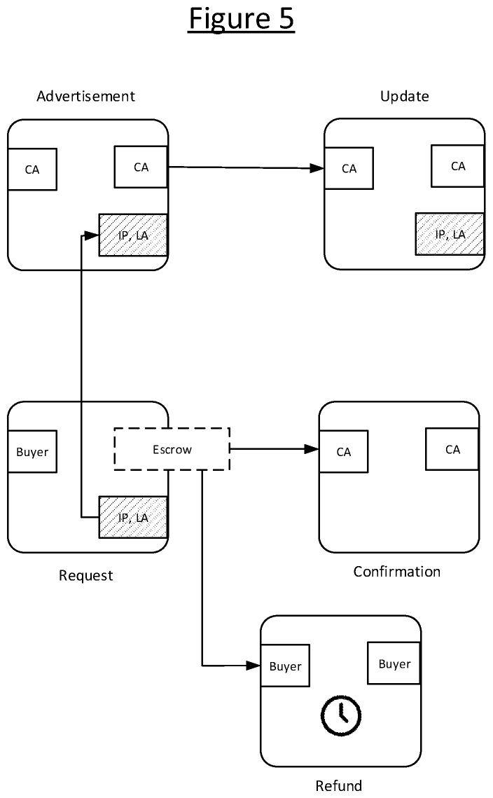

FIG. 5 illustrates the five main transactions described above which form the basis of the underlying system of the blockchain licensing protocol, and the ways in which these transactions are linked. The striped boxes are OP_RETURN outputs comprising data. Solid arrow shows the assignment of an output. The left-hand side boxes of transaction are inputs and the right-hand side boxes are outputs. The clock represents a time-locked transaction and LA′ is an updated version of the LA.

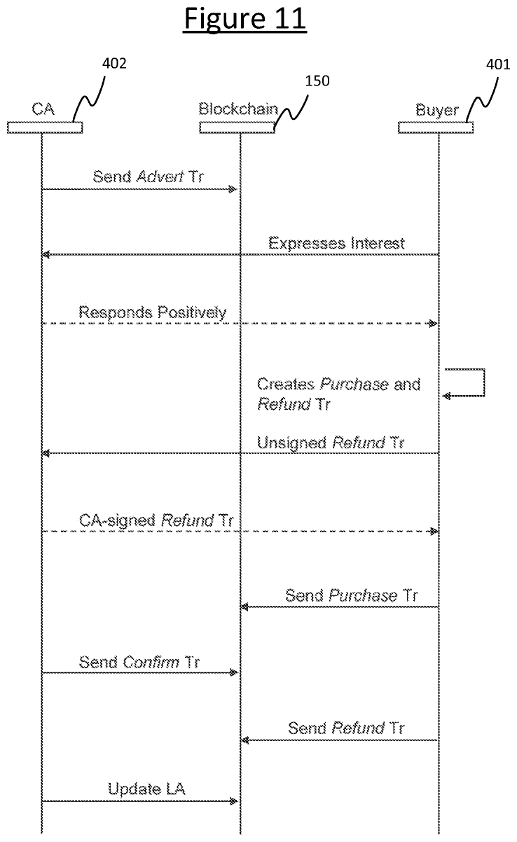

FIG. 11 illustrates an example sequence of the BLP. As shown, the CA sends an advertisement transaction to the blockchain 150. A buyer expresses interest in the LA and the CA responds positively, e.g. provisionally agrees to license the IP to the buyer. The buyer then creates the purchase transaction and the refund transaction. The buyer sends an unsigned refund transaction to the CA, which signs the transaction and returns it to the buyer. After receiving the signed refund transaction, the buyer submits the purchase transaction to the blockchain 150. The CA confirms the agreement by sending a confirmation transaction to the blockchain 150. Alternatively, the buyer could revoke the request to license the IP by sending a signed refund transaction to the blockchain 150. If the CA would like to update the offered agreement, the CA sends an update to the blockchain 150.

### Use Cases of the BLP

The blockchain licensing protocol (BLP) may be used for a variety of agreement types, despite the above examples having a clear focus on its application to licensing articles of intellectual property (IP). There are many other potential applications for the same techniques: utilising bilateral hash puzzle agreements (BHPAs) and a set of a transactions customised to the specific use case. Such use cases may include:
Licensing IP directly on-chain,
Distribution and management of public licenses, and
Supply chain acknowledgements.

### Licensing IP On-Chain

A use case for the BLP is for independent creators of digital content and media, which are themselves the intellectual property of the creator, to license their work using the blockchain 150. The key advantage here of using the BLP is that it allows creators to establish their own license agreements for their digital content that can be directly monetised using the native digital asset infrastructure of the blockchain itself. For instance, consider the steps a music artist Alice, who wants to license her music using the BLP, may take:
1. Create music (IP) and represent it uniquely on the blockchain.
2. Define LAs for using her music, which may entail more granular agreements down to the level of an individual song or album. These agreements may define different conditions for different types of usage of her music.
3. Establish LAs on-chain using the BLP.
4. Listeners purchase license to listen/reuse/distribute her music on a case-by-case basis.

Alice does not require a third party to mediate the process of coming to an agreement with users (i.e. licensees), as this is enforced using the BHPA aspect of the BLP, which also leaves a digitally signed proof of consent for both parties. An advantage of this use case is that the proof of consent in the BHPA is tied to the movement of digital assets related to the licensing of the music to individual users, which allows Alice to be paid immediately upon a user agreeing to terms of service/use. This also has the benefit for the user of being able to pay granularly for content using small micropayments, on a song-by-song or listen-by-listen basis depending on the details of the LA, rather than having to undertake a longer-term subscription.

### Distribution of Regulatory Licenses

The BLP mechanism may also be particularly suited to the definition, issuance, and handling of licenses granted by regulatory or governmental bodies. Such licenses may include TV licenses, license to serve alcohol or license to drive a certain type of vehicle. The BLP provides the necessary functions of issuance, purchase, update, and revocation that are generally required for these licenses. In this case, it may not be necessary to tie the BLP to an article of ‘intellectual property’ as the licenses in question are related to the regulating body (licensor) granting authorisation to a user or company (licensee) to either use or provide certain goods, services and activities.

### Supply Chain Acknowledgements

A potential extended application of the BLP, and in particular the BHPAs underpinning the system, is for use in a complex supply chain. The concept here is that the proof of consent provided by a BHPA is to be used as a ‘proof of acknowledgement’ in a supply chain. A proof of acknowledgement, in the context of a supply chain, is a proof that a given stakeholder or participant in that supply chain has acknowledged their responsibilities upon receipt of a certain good, or notification that they are to perform a certain task. The use of a BHPA in this scenario is advantageous as it provides evidence that both the stakeholder receiving instructions or goods and the stakeholder in the supply chain conferring the instructions or goods agree to the terms upon which this happens. This is akin to evidencing stakeholder agreements in a supply chain. The BLP improves standard stakeholder agreements by allowing them to be created and accepted ‘on-the-fly’ by using the blockchain to ensure that all of these agreements are provably evidenced and linked together.

In implementing the BLP in the case of a supply chain, it may be desirable to chain multiple such sets of BLP transaction together to mimic the supply chain itself. Simply by connecting one set of BLP transactions, relating to a particular agreement between stakeholders, to the next can be achieved by enforcing spending links between transactions.

### CONCLUSION

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In non-preferred embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

It will be appreciated that the above embodiments have been described by way of example only. More generally there may be provided a method, apparatus or program in accordance with any one or more of the following Statements.

Statement 1. A computer-implemented method of recording an agreement between a requesting party and a confirming party on a blockchain, wherein the method is performed by the requesting party and comprises:
generating a request transaction, wherein the request transaction comprises an input signed by the requesting party, and at least a first output comprising a cryptographic puzzle based on a first data item known to both the requesting and confirming parties, wherein the first data item represents the agreement; and
causing the request transaction to be transmitted to one or more blockchain nodes.

Said causing may comprise transmitting the request transaction directly to the blockchain node(s), or to another party (e.g. the confirming party) for forwarding to the blockchain node(s).

In some embodiments, at least one condition for an input to unlock the first output is that the input must comprise the data item.

In general, the agreement represented by the first data item may be any contract, treaty, covenant, pact, deal, settlement, arrangement, pledge, bond, sale, etc. between the requesting and confirming parties. However the agreement is not a public key.

Statement 2. The method of statement 1, wherein the first data item comprises the agreement, or wherein the first data item comprises a hash of at least the agreement.

Statement 3. The method of statement 1 or statement 2, wherein the first output comprises a second cryptographic puzzle based on a second data item known to both the requesting and confirming parties, wherein the second data item represents an identifier of the requesting party.

The second data item may comprise the identifier, or the second data item may comprise a hash of the identifier.

Statement 4. The method of any preceding statement, wherein the request transaction comprises one of more additional data items, and wherein the one or more additional data items comprise one, some or all of:
a double-hash of the agreement,
a double-hash of the identifier of the requesting party,
an indicator indicating that the request transaction represents a request for the agreement, and
a reference to an advertisement transaction comprising an indicator indicating that the advertisement transaction represents an advertisement of the agreement.

Statement 5. The method of statement 4, wherein the request transaction comprises a second output comprising one, some or all of the additional data items.

The second output may be an unspendable output.

Statement 6. The method of any preceding statement, wherein the first output is configured to be unlocked by an input of a refund transaction on condition that the input of the refund transaction comprises a respective signature associated with the requesting party and/or the confirming party.

Statement 7. The method of statement 6, wherein the first output comprises a multi-signature locking script.

Statement 8. The method of statement 6 or statement 7, comprising:
obtaining a refund transaction, wherein the refund transaction comprises an input referencing the first output of the request transaction and comprising a respective signature associated with the requesting party and/or the confirming party, and wherein the refund transaction comprises an output locked to the requesting party; and
causing the refund transaction to be transmitted to one or more blockchain nodes.

For instance, the output of the refund transaction may be locked to a public key of the requesting party.

Statement 9. The method of statement 8, comprising;
generating an unsigned version of the refund transaction; and
transmitting an unsigned version of the refund transaction to the confirming party.

Statement 10. The method of statement 9, wherein said obtaining of the refund transaction comprises:
receiving a version of the refund transaction comprising the input comprising the respective signature associated with the confirming party; and
signing the input with the respective signature associated with the requesting party.

Statement 11. The method of any of statements 8 to 10, wherein the refund transaction comprises a time restriction configured to prevent the refund transaction from being published on the blockchain before a specified time has passed.

The specified time may be measured in, for example, UNIX time or block height.

Statement 12. The method of any preceding statement, wherein the first output of the request transaction comprises, in a locking script, a separator opcode, followed by the cryptographic puzzle based on the first data item, followed by a signature checking opcode.

For instance, the separator opcode may be OP_CODESEPERATOR and the signature checking opcode may be OP_CHECKSIG. Note that more data than just the cryptographic puzzle may be included after the separator opcode. The cryptographic puzzle need not necessarily immediately follow the separator opcode, nor need it necessarily immediately precede the signature checking opcode. Similarly, some data that does not need to be signed by the confirming party may be included prior to the separator opcode. In other words, to get the desired effect of the confirming party not needing to sign all of the locking script, the data not being signed must precede the OP_CODESEPARATOR.

Statement 13. The method of any preceding statement, wherein the cryptographic puzzle comprises a one-way function.

Statement 14. The method of any preceding statement, wherein the cryptographic puzzle comprises one of: a hash puzzle, a private key puzzle, or an r-puzzle.

In some examples, the second cryptographic puzzle may comprise one of: a hash puzzle, a private key puzzle, or an r-puzzle. The first and second cryptographic puzzles may comprise the same type of puzzle, or different types.

Statement 15. A computer-implemented method of recording an agreement between a requesting party and a confirming party using a blockchain, wherein the method is performed by the confirming party and comprises:
generating a confirmation transaction, wherein the confirmation transaction comprises an input referencing an output of a request transaction, wherein the output of the request transaction comprises a cryptographic puzzle based on a first data item known to both the requesting and confirming parties and representing the agreement, and wherein the input of the confirmation transaction comprises the first data item; and
causing the confirmation transaction to be transmitted to one or more blockchain nodes.

Said causing may comprise transmitting the confirmation transaction directly to the blockchain node(s), or to another party (e.g. the requesting party) for forwarding to the blockchain node(s).

Statement 16. The method of statement 15, wherein the input of the confirmation transaction comprises a signature associated with the confirming party.

Statement 17. The method of statement 16, wherein the first output of the request transaction comprises, in a locking script, a separator opcode, followed by the cryptographic puzzle based on the first data item, followed by a signature checking opcode, and wherein the signature associated with the confirming party is configured to sign only data positioned after the separator opcode.

Note that a signature checking opcode, e.g. OP_CHECKSIG, may be configured to check (i.e. verify) that a signature in an input of second transaction has signed a message using a private key corresponding to a public key included in an output of a first transaction referenced by the input of the second transaction.

Statement 18. The method of statement 16 or statement 17, wherein the output of the request transaction comprises a cryptographic puzzle based on a second data item known to both the requesting and confirming parties and representing an identifier of the requesting party, and wherein the input of the confirmation transaction comprises the second data item.

Statement 19. The method of any of statements 15 to 18, wherein the confirmation transaction comprises an output locked to the confirming party.

The output of the confirmation transaction may be locked to a public key associated with the confirming party.

Statement 20. The method of statement 19, comprising:
generating a revocation transaction, wherein the revocation transaction comprises an input configured to unlock the output of the confirmation transaction; and
causing the revocation transaction to be transmitted to one or more blockchain nodes.

The input of the revocation transaction may comprise a signature associated with the confirming party.

Statement 21. The method of any of statements 15 to 20, comprising:
generating an advertisement transaction, wherein the advertisement transaction comprises at least a first input signed by the confirming party, and at least a first output comprising one or both of a representation of the agreement, and an encrypted version of the agreement; and
causing the advertisement transaction to be transmitted to one or more blockchain nodes.

The first output may be an unspendable output.

Statement 22. The method of statement 21, wherein the representation of the agreement comprises a hash of the agreement, or wherein the representation of the agreement comprises a double-hash of the agreement.

Statement 23. The method of statement 21 or statement 22, wherein the first output comprises an indicator indicating that the advertisement transaction is an advertisement of the agreement.

Statement 24. The method of any of statements 21 to 23, wherein the advertisement transaction comprises one or more additional inputs, each additional input signed by a different party.

Statement 25. The method of any of statements 21 to 24, wherein the advertisement transaction comprises a second output locked to the confirming party.

The second output of the advertisement transaction may be locked to a public key associated with the confirming party. The second output may or may not be a different output compared to the first output.

Statement 26. The method of statement 25, comprising:
generating an update transaction, wherein the update transaction comprises an input configured to unlock the second output of the advertisement transaction, and at least a first output comprising one or both of a representation of an updated agreement, and an encrypted version of the updated agreement; and
causing the update transaction to be transmitted to one or more blockchain nodes.

Statement 27. The method of any preceding statement, wherein the agreement is a licensing agreement, for instance, a licensing agreement for an article of intellectual property.

Statement 28. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 27.

Statement 29. A computer program embodied on computer-readable storage and configured so as, when run on computer equipment, to perform the method of any of statements 1 to 27.

According to another aspect disclosed herein, there may be provided a method comprising the actions of the requesting party and the confirming party.

According to another aspect disclosed herein, there may be provided a system comprising the computer equipment of the requesting party and the confirming party.

1. A computer-implemented method of recording an agreement between a requesting party and a confirming party on a blockchain, wherein the method is performed by the requesting party and comprises:
generating a request transaction, wherein the request transaction comprises an input signed by the requesting party, and at least a first output comprising a cryptographic puzzle based on a first data item known to both the requesting and confirming parties, wherein the first data item represents the agreement; and
causing the request transaction to be transmitted to one or more blockchain nodes.

2. The method of claim 1, wherein the first data item comprises the agreement, or wherein the first data item comprises a hash of at least the agreement.

3. The method of claim 1, wherein the first output comprises a second cryptographic puzzle based on a second data item known to both the requesting and confirming parties, wherein the second data item represents an identifier of the requesting party.

4. The method of claim 1, wherein the request transaction comprises one of more additional data items, and wherein the one or more additional data items comprise one, some or all of:
a double-hash of the agreement,
a double-hash of an identifier of the requesting party,
an indicator indicating that the request transaction represents a request for the agreement, and
a reference to an advertisement transaction comprising an indicator indicating that the advertisement transaction represents an advertisement of the agreement.

5. (canceled)

6. The method of claim 1, wherein the first output is configured to be unlocked by an input of a refund transaction on condition that the input of the refund transaction comprises a respective signature associated with the requesting party and/or the confirming party.

7. (canceled)

8. The method of claim 6, comprising:
obtaining a refund transaction, wherein the refund transaction comprises an input referencing the first output of the request transaction and comprising a respective signature associated with the requesting party and/or the confirming party, and wherein the refund transaction comprises an output locked to the requesting party;
causing the refund transaction to be transmitted to one or more blockchain nodes
generating an unsigned version of the refund transaction; and
transmitting an unsigned version of the refund transaction to the confirming party.

9. (canceled)

10. The method of claim 6, wherein said obtaining of the refund transaction comprises:
receiving a version of the refund transaction comprising the input comprising the respective signature associated with the confirming party; and
signing the input with the respective signature associated with the requesting party.

11. (canceled)

12. The method of claim 1 wherein the first output of the request transaction comprises, in a locking script, a separator opcode, followed by the cryptographic puzzle based on the first data item, followed by a signature checking opcode.

13. (canceled)

14. The method of claim 1, wherein the cryptographic puzzle comprises one of: a hash puzzle, a private key puzzle, or an r-puzzle.

15. A computer-implemented method of recording an agreement between a requesting party and a confirming party using a blockchain, wherein the method is performed by the confirming party and comprises:
generating a confirmation transaction, wherein the confirmation transaction comprises an input referencing an output of a request transaction, wherein the output of the request transaction comprises a cryptographic puzzle based on a first data item known to both the requesting and confirming parties and representing the agreement, and wherein the input of the confirmation transaction comprises the first data item; and
causing the confirmation transaction to be transmitted to one or more blockchain nodes.

16. The method of claim 15, wherein the input of the confirmation transaction comprises a signature associated with the confirming party, and wherein the first output of the request transaction comprises, in a locking script, a separator opcode, followed by the cryptographic puzzle based on the first data item, followed by a signature checking opcode, and wherein the signature associated with the confirming party is configured to sign only data positioned after the separator opcode.

17. (canceled)

18. The method of claim 16, wherein the output of the request transaction comprises a cryptographic puzzle based on a second data item known to both the requesting and confirming parties and representing an identifier of the requesting party, and wherein the input of the confirmation transaction comprises the second data item.

19. The method of claim 15, wherein the confirmation transaction comprises an output locked to the confirming party.

20. The method of claim 19, comprising:
generating a revocation transaction, wherein the revocation transaction comprises an input configured to unlock the output of the confirmation transaction; and
causing the revocation transaction to be transmitted to one or more blockchain nodes.

21. The method of claim 15, comprising:
generating an advertisement transaction, wherein the advertisement transaction comprises at least a first input signed by the confirming party, and at least a first output comprising one or both of a representation of the agreement, and an encrypted version of the agreement; and
causing the advertisement transaction to be transmitted to one or more blockchain nodes.

22. The method of claim 21, wherein the representation of the agreement comprises a hash of the agreement, or wherein the representation of the agreement comprises a double-hash of the agreement.

23-24. (canceled)

25. The method of claim 21, wherein the advertisement transaction comprises a second output locked to the confirming party, and wherein the method comprises:
generating an update transaction, wherein the update transaction comprises an input configured to unlock the second output of the advertisement transaction, and at least a first output comprising one or both of a representation of an updated agreement, and an encrypted version of the updated agreement and
causing the update transaction to be transmitted to one or more blockchain nodes.

26. (canceled)

27. The method of claim 10, wherein the agreement is a licensing agreement.

28. Computer equipment comprising:
memory comprising one or more memory units; and
processing apparatus comprising one or more processing units, wherein the memory stores code arranged to run on the processing apparatus, the code being configured so as when run on the processing apparatus, the processing apparatus performs a method of recording an agreement between a requesting party and a confirming party on a blockchain, wherein the method is performed by the requesting party and comprises:
generating a request transaction, wherein the request transaction comprises an input signed by the requesting party, and at least a first output comprising a cryptographic puzzle based on a first data item known to both the requesting and confirming parties, wherein the first data item represents the agreement and
causing the request transaction to be transmitted to one or more blockchain nodes.

29. A computer program embodied on a non-transitory computer-readable storage medium and configured so as, when run on computer equipment, the computer equipment performs a method of recording an agreement between a requesting party and a confirming party on a blockchain, wherein the method is performed by the requesting party and comprises:
generating a request transaction, wherein the request transaction comprises an input signed by the requesting party, and at least a first output comprising a cryptographic puzzle based on a first data item known to both the requesting and confirming parties, wherein the first data item represents the agreement and
causing the request transaction to be transmitted to one or more blockchain nodes.
